(19) United States
(12) Patent Application Publication
(10) Pub. No.: US 2010/0148403 A1
(43) Pub. Date: Jun. 17, 2010

(54) Systems and Methods For Manufacturing Cast Silicon

(75) Inventors: Nathan G. Stoddard, Gettysburg, PA (US); Roger F. Clark, Knoxville, MD (US)

Correspondence Address: CAROL WILSON;BP AMERICA INC., MAIL CODE 5 EAST, 4101 WINFIELD ROAD, WARRENVILLE, IL, 60555, US

(73) Assignee: BP Corporation North America Inc., Warrenville, IL (US)

(21) Appl. No.: 12/638,023

(22) Filed: Dec. 15, 2009

Related U.S. Application Data
(60) Provisional application No. 61/122,934, filed on Dec. 16, 2008.

(51) Int. Cl. H05B 6/02; H05B 6/10

(52) U.S. Cl. 264/431; 425/3

(57) ABSTRACT

Apparatus and methods are provided for manufacturing cast silicon. The systems and methods include a plurality of inductive coils configured to form a space to contain molten silicon, and configured to generate an electromagnetic field when an electrical current is supplied to the inductive coils to support the molten silicon so that a gap is maintained in a portion of the space between at least one substantially vertical wall of the molten silicon and at least one of the inductive coils, and when a portion of the molten silicon solidifies into a solid silicon ingot as the molten silicon is cooled by the cooling device, a concave liquid/solid interface is formed between the molten silicon and the solid silicon ingot.

This application claims the benefit of U.S. Provisional Patent Application No. 61/122,934, filed on Dec. 16, 2008, which is hereby incorporated by reference in its entirety.

This invention was made with U.S. Government support under National Renewable Energy Laboratory (NREL) Subcontract No. ZDO-2-30628-03 under Department of Energy (DOE) Contract No. DE-AC36-98GO10337, awarded by DOE. The U.S. Government has certain rights in this invention.

### TECHNICAL FIELD

The present invention generally relates to the field of photovoltaics and to systems and methods for manufacturing cast silicon for photovoltaic applications.

### BACKGROUND INFORMATION

Silicon is generally used to fabricate photovoltaic cells that convert light into electrical current because of its reasonable cost, and because of its suitable balance of electrical, physical, and chemical properties. In a known procedure for the manufacture of photovoltaic cells, silicon feedstock is mixed with a material (or dopant) for inducing either a positive or negative conductivity type, melted, and then crystallized by either pulling crystallized silicon out of a melt zone into ingots of monocrystalline silicon (via the Czochralski (CZ) or float zone (FZ) methods), or cast into blocks or “bricks” of multi-crystalline silicon or polycrystalline silicon, depending on the grain size of the individual silicon grains. In the procedure described above, the ingots or blocks are cut into thin substrates, also referred to as wafers, by known slicing or sawing methods. These wafers may then be processed into photovoltaic cells.

Monocrystalline silicon for use in the manufacture of photovoltaic cells is generally produced by the CZ or FZ methods, both being processes in which a cylindrically shaped boule of crystalline silicon is produced. For a CZ process, the boule is slowly pulled out of a pool of molten silicon. For a FZ process, solid material is fed through a melting zone and re-solidified on the other side of the melting zone. A boule of monocrystalline silicon, manufactured in these ways, contains a radial distribution of impurities and defects, such as rings of oxygen-induced stacking faults (OSF) and “swirl” defects of interstitial or vacancy clusters. Even with the presence of these impurities and defects, monocrystalline silicon is generally a preferred source of silicon for producing photovoltaic cells, because it can be used to produce high efficiency solar cells. Monocrystalline silicon is, however, more expensive to produce than conventional multi-crystalline silicon, using known techniques such as those described above.

Conventional multi-crystalline silicon for use in the manufacture of photovoltaic cells is generally produced by a casting process. Casting processes for preparing conventional multi-crystalline silicon are known in the art of photovoltaic technology. Briefly, in such processes, molten silicon is contained in a crucible, such as a fused silica crucible, and is cooled in a controlled manner to permit the crystallization of the silicon contained therein. The block of crystalline silicon that results is generally cut into bricks having a cross-section that is the same as or close to the size of the wafer to be used for manufacturing a photovoltaic cell, and the bricks are sawed or otherwise cut into such wafers. Multi-crystalline silicon produced in such manner is typically an agglomeration of crystal grains where, within the wafers made therefrom, the orientation of the grains relative to one another is effectively random.

The random orientation of grains, in either conventional multi-crystalline or poly-crystalline silicon, makes it difficult to texture the surface of a resulting wafer. Texturing is used to improve efficiency of a photovoltaic cell, by reducing light reflection and improving light energy absorption through the surface a cell. Additionally, “kinks” that form in the boundaries between the grains of conventional multi-crystalline silicon tend to nucleate structural defects in the form of clusters or lines of dislocations. These dislocations, and the impurities they tend to attract, are believed to cause a fast recombination of electrical charge carriers in a functioning photovoltaic cell made from conventional multi-crystalline silicon. This can cause a decrease in the efficiency of the cell. Photovoltaic cells made from such multi-crystalline silicon generally have lower efficiency compared to equivalent photovoltaic cells made from monocrystalline silicon, even considering the radial distribution of defects present in monocrystalline silicon produced by known techniques. However, because of the relative simplicity and lower costs for manufacturing conventional multi-crystalline silicon, as well as effective defect passivation in cell processing, multi-crystalline silicon is a more widely used form of silicon for manufacturing photovoltaic cells.

Some previous casting techniques involved using a “cold-wall” crucible for crystal growth. The term “cold-wall” refers to the fact that induction coils present on or in the walls of the crucible are water cooled, and may also be slotted, thus generally remaining below 100° C. The crucible walls may be situated in close proximity between the coils and the feedstock. The material of the crucible walls is not particularly thermally insulating, and can therefore remain in thermal equilibrium with the cooled coils. The heating of the silicon is therefore not predicated on radiation from the crucible walls, because inductive heating of the silicon in the crucible means that the silicon is heated directly by current induced to flow therein. In this way, the walls of the crucible remain below the melting temperature of the silicon, and are considered “cold,” relative to the molten silicon. During solidification of the inductively heated molten silicon, these cold walls of the crucible act as a heat sink. The ingot cools quickly, determined by radiation to the cold walls. Therefore, an initial solidification front quickly becomes substantially curved, with crystal nucleation occurring at the ingot sides and growing diagonally towards the ingot center, disrupting any attempt at maintaining a vertical and geometrically ordered seeding process or a substantially flat solidification front.

Recent advances have been made in casting of materials, such as silicon, for applications in the photovoltaic industry. Such advances are described, for example, in copending application Ser. Nos. 11/624,365 and 11/624,411, filed Jan. 18, 2007. Materials, such as those used to form semiconducting substrates or wafers, may include combinations of elements from Groups II-VI, III-V, and IV-IV. As used herein, the term “material,” unless otherwise specified, includes any element or combination of elements from Groups II-VI, III-V, and IV-IV, in particular those which may be formed into semiconductor wafers or substrates.

FIGS. 1-3 from PCT/US2008/070187, filed Jul. 16, 2008, which claims the benefit of U.S. Provisional Application No. 60/951,151, illustrates a method and system for casting a material, such as silicon, in a bottomed and walled crucible.

Referring to FIG. 1, seeds 100 may be placed at the bottom of a bottomed and walled crucible 110, such as a quartz crucible, in a way such that either they closely abut in the same orientation so as to form a large, continuously oriented slab 120. Alternatively, they closely abut in pre-selected misorientations so as to produce specific grain boundaries with deliberately chosen grain sizes in the resulting silicon.

Seeds 100 may be tiled and may be preferably placed so as to substantially cover the entirety of the bottom of crucible 110. It may be preferable that crucible 110 has a release coating such as one made from silica, silicon nitride, or a liquid encapsulant, to aid in the removal of crystallized silicon from crucible 110. Further, the seeds may comprise a slab or slabs of monocrystalline silicon of a desired crystal orientation, or two different desired crystal orientations. While a specific number and size of seeds 100 is shown in FIG. 1, it will be readily apparent to one of ordinary skill in the art that both the number and size of the seeds can be increased or decreased, depending on the application.

Referring to FIG. 2, a plan view of an alternative arrangement of seeds 300 and 310 is presented. In FIG. 2, seeds 300 and 310 may be placed at the bottom of a bottomed and walled crucible (not shown), such as crucible 110 shown in FIG. 1, in a way such that they closely abut in two different crystal orientations so as to cover, or nearly completely cover, a full width 320 of a bottom surface of a bottomed and walled crucible. Consistent with the present invention, the seeds 300 and 310 may be single crystal silicon pieces. Preferably, seeds 300 may have a (100) crystal orientation, while seeds 310 may have a (111) crystal orientation, such that their respective pole directions are perpendicular to the bottom surface of crucible 110. As shown in FIG. 2, a series of (111) seeds 310 may be selectively placed so as to surround a series of (100) seeds 300. While seeds 310 are shown in FIG. 2, having a (111) pole direction perpendicular to the bottom surface of crucible 110, other crystal orientations may be possible for seeds 310. Preferably, seeds 300 may have a different crystal orientation than seeds 310. Seeds 300 can be placed on a bottom surface of the crucible, and seeds 310 can be placed on the periphery area of the bottom of the crucible not occupied by seeds 300. Ingots produced by silicon casting with respect to the use of seeds 300 and 310 will be described later with reference to FIG. 3.

Consistent with the seed layouts (or patterns) disclosed in FIGS. 1-2, for example, silicon feedstock (not shown) may then be introduced into crucible 110 over seeds 100, 300, and/or 310, and then melted. Alternatively, molten silicon may be placed into crucible 110, for example, by pouring. In the alternative example, crucible 110 may be first brought very close to, or up to, the melting temperature of silicon before the molten silicon is placed or poured in. Consistent with embodiments of the invention, a thin layer of the seeds can be melted before solidification begins.

Then, in any of the examples discussed above, crucible 110 is cooled, whereby heat is removed from the bottom of crucible 110 (and sides only if seeds are tiled on the side surfaces as well) by, for example, a solid heat sink material which radiates heat to the ambient, while heat is still applied to the open top of crucible 110. Thus, melted silicon is introduced while the seed is maintained as a solid, and directional solidification of the melt causes the upwards growth of the columnar grains. In this way, the resulting cast ingot of silicon will mimic the crystal orientations of the silicon seeds 100 or 300 and 310. The resulting ingot can be cut into, for example, horizontal slabs to act as seed layers for other casting processes.

Referring to FIG. 3, a vertical cross section is shown through the middle of crucible 110 after solidification of an ingot of cast silicon 400. A plan view of the line 2-2 in FIG. 3 corresponds to the seed layout or pattern illustrated in FIG. 2. In the example illustrated in FIG. 3, (100) seeds 300 are placed on the bottom surface of crucible 110, as shown in the plan view of FIG. 2, with the exception that (111) seeds are not placed surrounding (100) seeds 300. In this example, the resulting ingot of silicon 400 is in contact with surfaces of the crucible that can serve as a multitude of nucleation sites for crystal growth of different grain orientations during the solidification phase of a casting process. A curved corner 410 of crucible 110, for example, may serve as a nucleation site for growth of a multicrystalline silicon region 420, the growth of which will compete with nucleation and growth of a (100) monocrystalline silicon region 430 from (100) seeds 300. During casting, multicrystalline silicon region 420 encroaches over the seeds 300, such that the resulting ingot 400 is part monocrystalline silicon and part multicrystalline silicon. The divisions between (100) monocrystalline silicon region 430 and multicrystalline silicon region 420 are illustrated by lines 440, which depict how multicrystalline silicon region 420 grows outward from its nucleation site at the corner 410. Thus, nucleation and growth of (100) monocrystalline silicon region 430 is eroded due to competitive lateral grain growth of randomly-oriented grains, for example, from the sidewalls of crucible 110.

Still referring to FIG. 3, after casting is completed, the resulting ingot of cast silicon 400 is cut into four or more rows of bricks 450 and two side plates 460. Side plates 460 are typically multicrystalline silicon and may contain impurities from the walls of crucible 110 diffused during casting. Side plates 460 are thus removed and may be used as feedstock for subsequent casting processes. If casting of (100) monocrystalline silicon is desired, at least three of the bricks 450 shown in FIG. 3 will contain (100) monocrystalline silicon. Two bricks 450 and both side plates 460 may contain multicrystalline silicon only, or a combination of multicrystalline silicon and monocrystalline silicon, as indicated by the bricks 450 through which lines 440 traverse. Thus, the volume yield of (100) monocrystalline silicon region 430 in ingot 400 will be reduced by the volume of multicrystalline silicon region 420.

One of the difficulties in manufacturing cast crystalline silicon (whether multicrystalline or monocrystalline) is that the silicon is melted and then solidified in contact with the crucible side walls. These side walls are typically coated with a release coating to prevent the adhesion of the ingot to the crucible. This release coating is typically silicon nitride. This or other release coatings will have an elemental composition which includes non-silicon impurities. The coating and the crucible also generally include trace elements such as iron, chromium, and other metals. In contact with liquid silicon, the release coating slowly dissolves, adding large amounts of nitrogen or other non-silicon impurities to the resultant ingot. This eventually leads to the presence of silicon nitride particles in the melted silicon which will be invariably present in the solidified ingot. Trace impurities may also become dissolved in the silicon, but get swept to the top of the ingot by a partitioning effect due to their low solubility in the solid. Even so, once material solidifies in contact with a side wall, solid-state diffusion of impurities begins, ultimately causing the peripheral silicon portion of the ingot in contact with the side walls to be unusable in subsequently manufactured solar cells.

Another type of system includes a bottomless crucible for casting silicon as disclosed in U.S. Pat. No. 6,027,563 to Choudhury et al., issued on Feb. 22, 2000 (“the '563 patent”). The system disclosed in the '563 patent is directed toward oriented solidification of molten silicon to form an ingot in a bottomless crystallization chamber with a cooling body. The apparatus includes a cold crucible, which is surrounded by an induction coil, and is bottomless. The apparatus also includes a cold body on which seeds are placed. The induction coil is coupled by way of the cold crucible to molten silicon placed on the seed body. Electrical current is supplied to the induction coil to generate a repelling electromagnetic force, which acts on the molten silicon to push the molten silicon away from the cold crucible. The cold body is retracted down as the ingot is gradually formed. The system disclosed in the '563 patent, however, contains water cooled induction coils that surround the cold crucible which tend to nucleate grain growth from the sides, which may quickly degrade any seeding. The high thermal gradients and random nucleation lead to poor grain structure, especially near the edges of the ingot. Furthermore, copper used in various components of the apparatus may contaminate the ingot.

### SUMMARY OF THE INVENTION

In accordance with the systems and methods described above, there is provided an apparatus for manufacturing cast silicon, comprising: a plate; a cooling device; molten silicon; and a plurality of inductive coils configured to form a space to contain the molten silicon, and configured to generate an electromagnetic field to support the molten silicon so that a gap is maintained in a portion of the space between at least one substantially vertical wall of the molten silicon and at least one of the inductive coils, and when a portion of the molten silicon solidifies into a solid silicon ingot as the molten silicon is cooled by the cooling device, a concave liquid/solid interface is formed between the molten silicon and the solid silicon ingot.

In accordance with the systems and methods described above, there is provided an apparatus for manufacturing cast silicon, comprising: a plate; a cooling device; molten silicon; and a plurality of inductive coils configured to form a space to contain the molten silicon, and configured to generate an electromagnetic field when an electrical current is supplied to the inductive coils to support the molten silicon so that a gap is maintained in a portion of the space between at least one substantially vertical wall of the molten silicon and at least one of the inductive coils, and when a portion of the molten silicon solidifies into a solid silicon ingot as the molten silicon is cooled by the cooling device, a liquid/solid interface is formed between the molten silicon and the solid silicon ingot such that at the liquid/solid interface the solid silicon ingot is convex toward the interface and the liquid molten silicon is concave toward the interface.

In accordance with the systems and methods described above, there is also provided a method of manufacturing cast silicon, comprising: placing at least one silicon seed on a plate; placing molten silicon onto the at least one seed; supplying an electrical current to a plurality of inductive coils; generating an electromagnetic field with a plurality of inductive coils to exert a force upon the molten silicon and form a gap between at least one substantially vertical wall of the molten silicon and at least one of the inductive coils; and cooling the molten silicon from the plate.

In accordance with the systems and methods described above, there is also provided a method of manufacturing cast silicon, comprising: placing at least one silicon seed on a plate; placing a silicon feedstock onto the at least one seed; supplying an electrical current to a plurality of inductive coils; generating heat with the plurality of inductive coils to melt at least a portion of the silicon feedstock into molten silicon; and generating an electromagnetic field with the plurality of inductive coils to exert a force upon the molten silicon and form a gap between at least one substantially vertical wall of the molten silicon and at least one of the inductive coils; and cooling the molten silicon from the plate to solidify at least a portion of the molten silicon into solid silicon ingot, wherein a liquid/solid interface between the molten silicon and the solid silicon ingot has a concave shape.

In accordance with the systems and methods described above, there is also provided an apparatus for manufacturing cast silicon, comprising: a plate; a cooling device; molten silicon; at least one inductive coil; and a crucible having at least one crucible wall vertically aligned with the at least one inductive coil, wherein the crucible wall and the at least one inductive coil are configured to form a space to contain the molten silicon, and wherein the at least one inductive coil is configured to generate an electromagnetic field to maintain a gap in the space between the molten silicon, the at least one inductive coil, and the at least one crucible wall.

In accordance with the systems and methods described above, there is also provided a method of manufacturing cast silicon, comprising: placing at least one silicon seed on a plate; placing molten silicon onto the at least one seed; generating an electromagnetic field with at least one inductive coil to exert a force upon the molten silicon and form a gap between the molten silicon and the at least one inductive coil; and cooling the molten silicon from the plate.

In accordance with the systems and methods described above, there is also provided a method of manufacturing cast silicon, comprising: placing at least one silicon seed on a plate; placing a silicon feedstock onto the at least one seed; supplying an electrical current to at least one inductive coil; generating heat with the at least one inductive coil to melt at least a portion of the silicon feedstock into molten silicon; generating an electromagnetic field with the at least one inductive coil to exert a force upon the molten silicon and form a gap between the molten silicon and the at least one inductive coil; and cooling the molten silicon from the plate to solidify at least a portion of the molten silicon into solid silicon ingot, wherein a liquid/solid interface between the molten silicon and the solid silicon ingot has a concave shape.

In accordance with the systems and methods described above, there is provided an apparatus for manufacturing cast electronic material, such as silicon, comprising: a plate; a cooling device; and a plurality of inductive coils configured to form a space to contain molten electronic material, and configured to generate an electromagnetic field to support molten electronic material so that a gap is maintained in a portion of the space between at least one substantially vertical wall of the molten electronic material and at least one of the inductive coils, and when a portion of the molten electronic material solidifies into a solid electronic material ingot as the molten electronic material is cooled by the cooling device, a concave liquid/solid interface is formed between the molten electronic material and the solid electronic material ingot.

In accordance with the systems and methods described above, there is also provided an apparatus for manufacturing a cast electronic material, such as silicon, comprising: a plate; a cooling device; and a plurality of inductive coils configured to form a space to contain molten electronic material, and configured to generate an electromagnetic field when an electrical current is supplied to the inductive coils to support molten electronic material so that a gap is maintained in a portion of the space between at least one substantially vertical wall of the molten electronic material and at least one of the inductive coils, and when a portion of the molten electronic material solidifies into a solid ingot of the electronic material as the molten electronic material is cooled by the cooling device, a liquid/solid interface is formed between the molten electronic material and the solid ingot of the electronic material such that at the liquid/solid interface the solid ingot of electronic material is convex toward the interface and the liquid molten electronic material is concave toward the interface.

In accordance with the systems and methods described above, there is also provided an apparatus for manufacturing cast electronic material, such as silicon, comprising: a plate; a cooling device; at least one inductive coil; and a crucible having at least one crucible wall vertically aligned with the at least one inductive coil, wherein the crucible wall and the at least one inductive coil are configured to form a space to contain molten electronic material, and wherein the at least one inductive coil is configured to generate an electromagnetic field to maintain a gap in the space between the molten electronic material, the at least one inductive coil, and the at least one crucible wall.

Additional features and advantages of the invention will be set forth in the description that follows, being apparent from the description or learned by practice of embodiments of the invention. It is to be understood that both the foregoing general description and the following detailed description are exemplary and explanatory, and are intended to provide further explanation of the invention as claimed.

### BRIEF DESCRIPTION OF THE DRAWINGS

The accompanying drawings, which are incorporated in and constitute a part of this specification, illustrate embodiments of the invention and, together with the description, serve to explain the features, advantages, and principles of the invention. For illustration purposes, none of the following drawings are to scale. In the drawings:

FIG. 1 illustrates an exemplary arrangement of silicon seeds on the bottom surface of a crucible;

FIG. 2 illustrates another exemplary arrangement of silicon seeds on the bottom and side surfaces of a crucible;

FIG. 3 illustrates a cross-section of a cast ingot using seed crystals having a single crystal orientation;

FIG. 4A illustrates a cross-sectional view of an exemplary apparatus for casting silicon consistent with an embodiment of present invention;

FIG. 4B illustrates an exemplary method for casting silicon with the exemplary apparatus shown in FIG. 4A consistent with an embodiment of present invention;

FIG. 5A illustrates a cross-sectional view of another exemplary apparatus for casting silicon consistent with an embodiment of present invention;

FIG. 5B illustrates an exemplary method for casting silicon with the exemplary apparatus shown in FIG. 5A consistent with an embodiment of present invention;

FIG. 6A illustrates a cross-sectional view of another exemplary apparatus for casting silicon consistent with an embodiment of present invention;

FIG. 6B illustrates an exemplary method for casting silicon with the exemplary apparatus shown in FIG. 6A consistent with an embodiment of present invention;

FIG. 7A illustrates a prior art apparatus showing a shape of liquid/solid interface between molten silicon and solidified silicon ingot contained in the apparatus; and

FIG. 7B illustrates a substantially rectangular shape of molten silicon contained in an exemplary apparatus consistent with an embodiment of present invention.

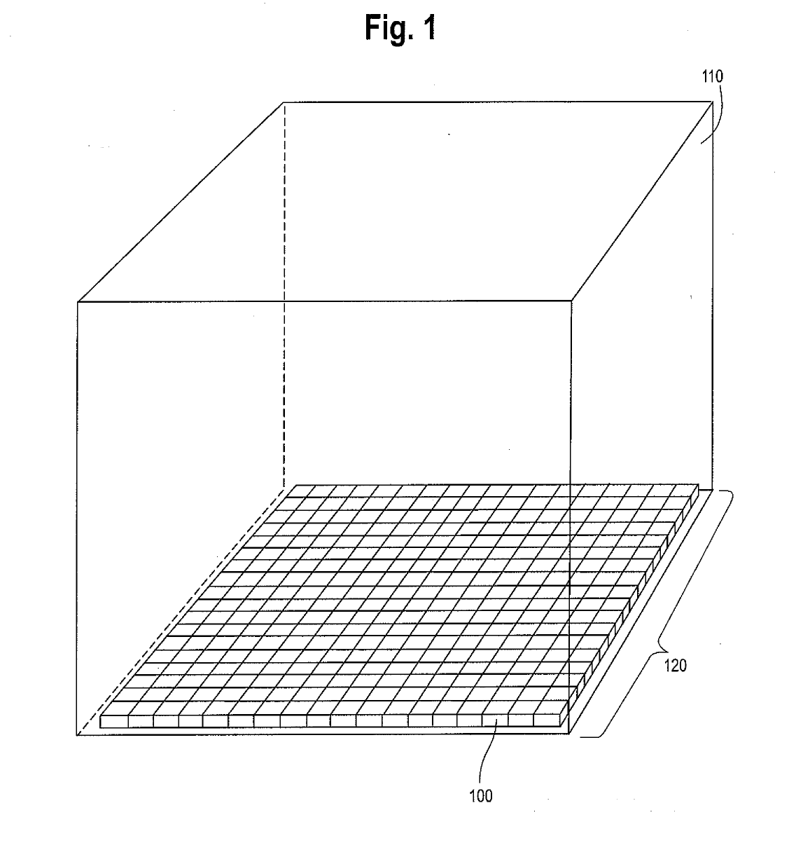

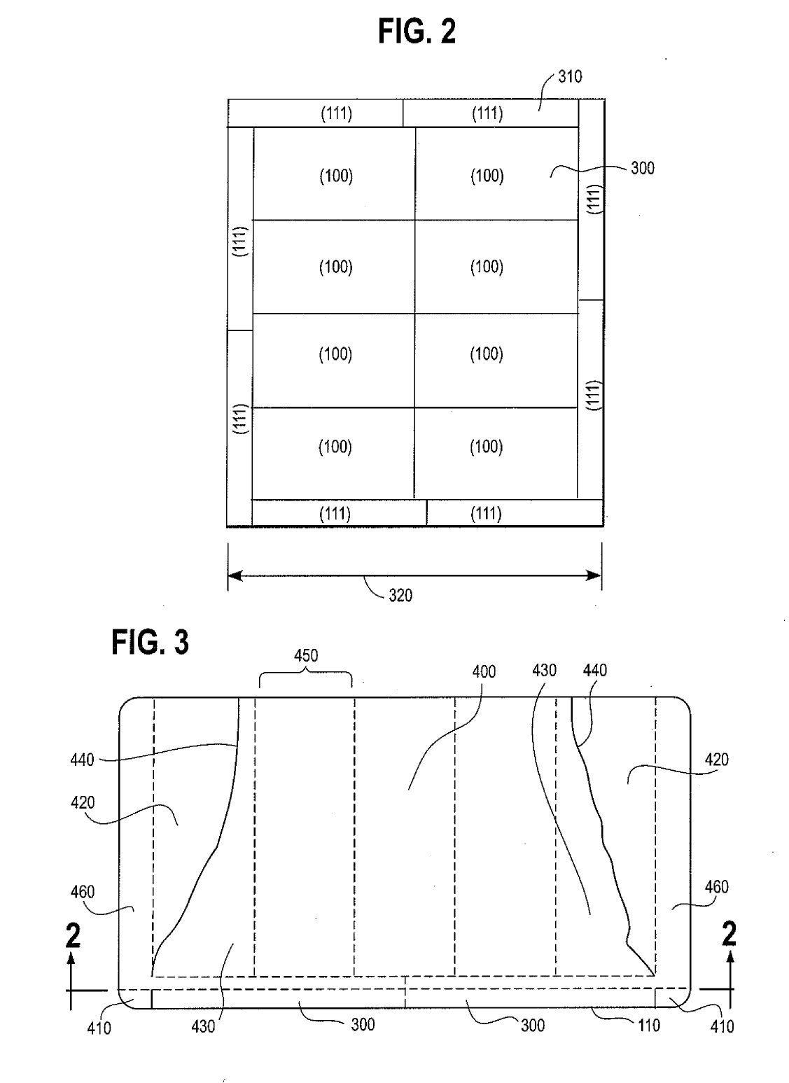

### DESCRIPTION OF THE EMBODIMENTS

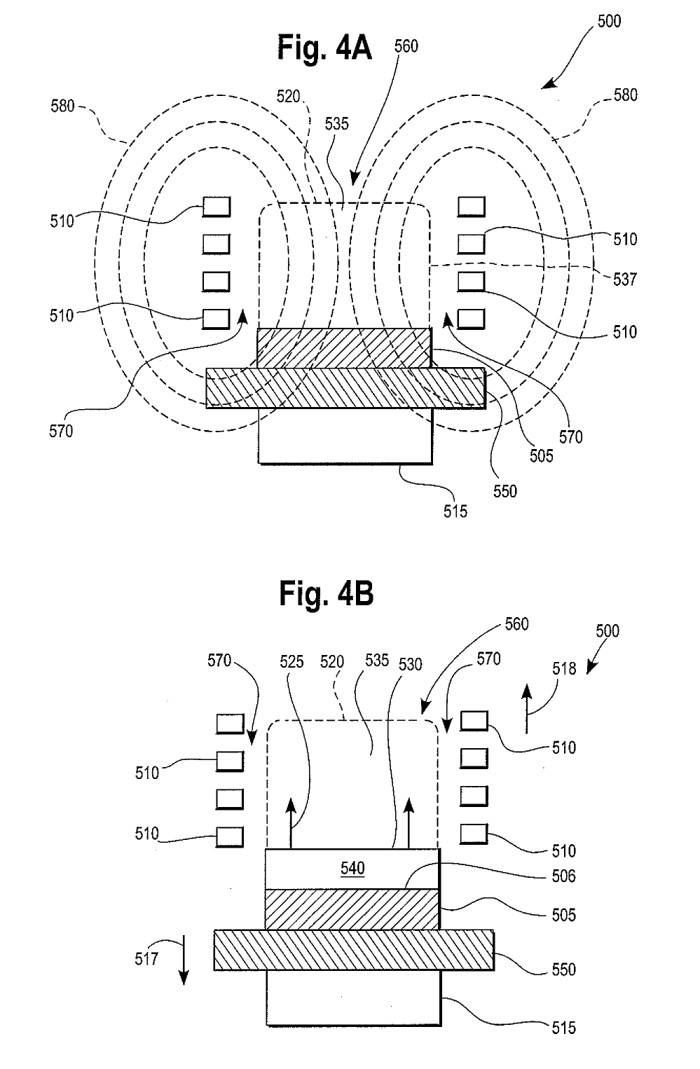

Reference will now be made in detail to embodiments of the present invention, examples of which are illustrated in the accompanying drawings (FIGS. 4-6). Wherever possible, the same or similar reference numbers will be used throughout the drawings to refer to the same or like parts.

FIG. 4A illustrates a cross-sectional view of an exemplary apparatus 500 for casting silicon consistent with an embodiment of the present invention. As shown in FIG. 4A, apparatus 500 does not require a bottomed and walled crucible for containing molten silicon. Furthermore, apparatus 500 does not require any bottomless walled crucible. In other words, apparatus 500 in the present invention may be a silicon casting apparatus without a crucible.

As shown in FIG. 4A, apparatus 500 may include a plate 550, a cooling device 515 attached to the bottom of plate 550, or integrated with plate 550, and at least one inductive coil 510. Preferably, apparatus 500 includes a plurality of inductive coils 510. Plate 550 may have any suitable shape, and may be made of any suitable material. At least one silicon seed 505 may be placed onto plate 550. The at least one silicon seed 505 may include one large piece of silicon seed, or may include a plurality of silicon seeds arranged to cover substantially all of a surface of plate 550 between coils 510.

The at least one inductive coil 510 may be made of any suitable material, for example, a refractory material such as graphite, SiC, etc. The at least one inductive coil 510 may include a single inductive coil wound a predetermined number of turns, or a plurality of individual inductive coils, or a plurality of individual groups of inductive coils. Each coil may be independently controlled when an electrical current is supplied thereto. Alternatively, all coils may be controlled simultaneously when an electrical current is supplied thereto. FIG. 4A shows cross sections of inductive coils, which can be of any shape, such as square, rectangle, circle, etc. For simplicity, the following discussion will only focus on the embodiments where a plurality of individual inductive coils are included in the at least one inductive coil 510. However, a person of ordinary skill in the art will appreciate that the discussion that follows may be applicable to other embodiments where a single coil or a plurality of groups of individual coils are included in the at least one inductive coil 510.

The plurality of inductive coils 510 may be configured to form a space 560 to contain molten silicon 535, and may be configured to generate an electromagnetic field 580 to support molten silicon 535 so that a gap 570 exists in a portion of space 560 between at least one substantially vertical wall 537 of molten silicon 535 and at least one of the inductive coils 510. Space 560 formed by inductive coils 510 may have any suitable shape, for example, a cylindrical shape, a cubic shape, etc. In some embodiments, space 560 enclosed by coils 510 may preferably have a square (or rectangular) cross-section, the size of which may be any suitable size based on a desirable size of the ingot that is to be formed therein. A square (or rectangular) cross-section may reduce the amount of wasted material when the ingot is formed. Space 560 may contain either or both of molten silicon 535 and solid silicon 540 solidified from molten silicon 535 during the casting process.

In one embodiment, silicon feedstock (not shown) may be placed into space 560 and onto silicon seed 505 and melted to produce molten silicon 535, which is then cooled and solidified, for example, by cooling device 515, to grow, for example, solid monocrystalline silicon. Melting of silicon feedstock may be conducted through any known technique in the art, for example, the technique disclosed in Applicants' copending application No. 60/951,151. Alternatively and preferably, silicon feedstock may be melted, for example, in a crucible other than apparatus 500, to obtain molten silicon 535 (i.e., liquid Si), which then may be placed into space 560. Preferably, apparatus 500 is used for the growth of monocrystalline silicon from molten silicon 535, which was melted in a crucible other than apparatus 500, although apparatus 500 may also be used for melting silicon feedstock.

As schematically illustrated in FIG. 4A, an electrical current (not shown) may be supplied to inductive coils 510 to generate an electromagnetic field 580 in spaces around inductive coils 510, which at least covers space 560 enclosed by inductive coils 510. The dotted and closed lines schematically illustrate the electromagnetic field 580. When the electrical current is supplied to inductive coils 510, heat may also be generated within space 560 when an electrically susceptive material is placed inside. Hot or doped silicon is sufficiently susceptive to be heated by induction, and thus feedstock may be melted to obtain molten silicon 535. Molten silicon 535 may also be coupled with electromagnetic field 580. An inductive current may be induced in molten silicon 535, which has high intrinsic conductivity and acts as a metal in the molten state. Due to the opposite direction of the induced current relative to the driving coil current, the electromagnetic field 580 will exert a repulsive force (not shown) on molten silicon 535, thereby providing support to molten silicon 535 such that it behaves as if it was being contained by a thin elastic wall. The repulsive force may hold molten silicon 535 substantially vertically and against the force of gravity. This repulsive force essentially “pushes” molten silicon 535 away from inductive coils 510, thereby preventing molten silicon 535 from contacting inductive coils 510. Due to the repulsive force, molten silicon 535 may form a liquid “block,” which may include at least one substantially vertical molten silicon wall 537.

A gap 570 may exist in a portion of space 560 between the at least one substantially vertical molten silicon wall 537 of molten silicon 535 and at least one of inductive coils 510, and may separate molten silicon 535 from the plurality of inductive coils 510. In other words, there is no crucible wall between molten silicon 535 and inductive coils 510. The at least one substantially vertical molten silicon wall 537 may be substantially straight or may contain surface disturbances due to convection within the molten silicon 535. Gap 570 may be substantially uniform along one or more sidewalls of molten silicon 535. It is also contemplated that the at least one substantially vertical molten silicon wall 537 may contain surface variations such that gap 570 may not be uniform along one or more sidewalls of molten silicon 535.

The magnitude of electromagnetic field 580, and thus the magnitude of the repulsive force, may be a function of various design parameters, such as the number of inductive coils 510, the amount of electrical current supplied to the inductive coils 510, the frequency of the alternating current, and the size of space 560 between inductive coils 510, etc. The magnitude of electromagnetic field 580 may be any desired level so that gap 570 may be maintained between molten silicon 535 and inductive coils 510. For example, in order to “hold” molten silicon 535 with a 12 cm height, gap 570 between molten silicon 535 and inductive coils 510 may be at least 2 mm wide, and in order to hold 24 cm of silicon, a smaller gap would result under the same electrical conditions. Due to the repulsive force, inductive coils 510, silicon seed 505, and plate 550, molten silicon 535 can be prevented from leaking out of space 560. Arbitrarily high currents can be used to produce large containment gaps or to hold large columns of liquid silicon, but there is a tradeoff when the purpose is to freeze the silicon in a desired way, in that higher currents cause much higher heating rates which make solidification more difficult.

Because of gap 570 between molten silicon 535 and inductive coils 510, molten silicon 535 is prevented from contacting inductive coils 510. Therefore, consistent with an embodiment, a monocrystalline silicon ingot 540 may be grown without any silicon contacting inductive coils 510 or any crucible side wall. Undesired nucleation and grain growth from the side wall are not necessarily prevented by the lack of side wall contact with molten silicon 535. For example, traditional cold crucible casting results in random nucleation of grains at the surface of the molten silicon due to extremely high temperature gradients between the hot molten silicon and the cold copper coils. However, if the silicon's heat could be contained, or if the inductive coils could be maintained hot, then nucleation and grain growth from the sides could be prevented, as shown in FIG. 4A.

Moreover, for prevention of adherence between inductive coils 510 and molten silicon 535 in case of occasional accidental or inadvertent contact between one or more of inductive coils 510 and molten silicon 535, inductive coils 510 may be coated with a material (not shown) comprising a non-stick and high temperature material. The material may be any suitable material, such as boron nitride, silicon nitride or SiC, etc., which may sustain temperatures, for example, at least as high as the melting point of silicon. Preferably, molten silicon 535 does not contact inductive coils 510 during casting. If molten silicon 535 does contact one or more inductive coils 510 due to, for example, a surface wave on the side of molten silicon 535, which may inductively couple molten silicon 535 to inductive coils 510, the material may ensure that molten silicon 535 does not adhere to inductive coils 510. Instead, molten silicon 535 will return to its equilibrium position under the influence of the repulsive force so that gap 570 between vertical molten silicon wall 537 and inductive coils 510 may be maintained. As a result of this non-contact casting process, molten silicon 535 may be grown into a single block of monocrystalline silicon ingot with substantially no contamination or undesired grain growth that may otherwise be attributable to side walls of a crucible.

Exemplary methods of operating apparatus 500 consistent with disclosed embodiments in a silicon casting process may be explained with reference to FIG. 4B. As mentioned above, molten silicon 535 may be obtained either from melting silicon feedstock using apparatus 500 or obtained in advance using a crucible other than apparatus 500. Consistent with an embodiment, molten silicon 535 may be obtained in advance using, for example, a crucible other than apparatus 500. Molten silicon 535 may be placed into space 560 and onto at least one silicon seed 505. Prior to placing molten silicon 535, an electrical current may be supplied to inductive coils 510 to generate an electromagnetic field 580 of an appropriate magnitude to exert a repulsive force on molten silicon 535 and thus contain it in space 560. Because of the repulsive force between inductive coils 510 and molten silicon 535, molten silicon 535 placed into space 560 may be a free-standing liquid block, as discussed above.

Consistent with an embodiment, molten silicon 535 may be obtained by melting silicon feedstock using apparatus 500. After the at least one silicon seed 505 is placed onto plate 550, silicon feedstock (not shown) may be placed onto silicon seed 505, and an electrical current may be supplied to inductive coils 510 to generate electromagnetic field 580 with an appropriate magnitude. The electrical current may also generate heat in space 560, which may be utilized to melt silicon feedstock to produce molten silicon 535. It is contemplated that continuous silicon casting may be achieved using the apparatus 500 illustrated in FIG. 4B. For example, as solid silicon ingot 540 is solidified from molten silicon 535, silicon feedstock may be continuously added into space 560, which is then continuously melted to produce molten silicon 535. Current situations where continuous or semi-continuous casting is done rely on feedstock that has been processed to have a small piece-size, so as not to overly perturb the molten silicon 535 by its addition. Preferably, liquid silicon is obtained from melting feedstock in advance, and this liquid silicon is fed into space 560 from the top in order to feed the continuous casting operation. The continuous or semi-continuous case may be more difficult to control than the batch case, due to the difficulties in controlling the cooling through a large portion of solidified ingot. For this reason, the batch case where an ingot is solidified with a height on the order of or less than its width, is believed to be the preferred embodiment.

Inductive coils 510 may be configured to be independently controlled when an electrical current is supplied thereto. The electrical current may be selectively supplied to predetermined coils. For example, before molten silicon 535 is placed into space 560, a number of lower coils at the bottom of space 560 may have already been supplied with an electrical current to generate electromagnetic field 580. As molten silicon 535 is continuously placed into space 560, the electrical current may be gradually supplied from the lowest coil moving upward along with the increase of the height of molten silicon 535. Alternatively, inductive coils 510 may be configured to be simultaneously controlled when the electrical current is supplied thereto. For example, before molten silicon 535 is placed into space 560, all coils may be supplied with an electrical current to generate electromagnetic field 580.

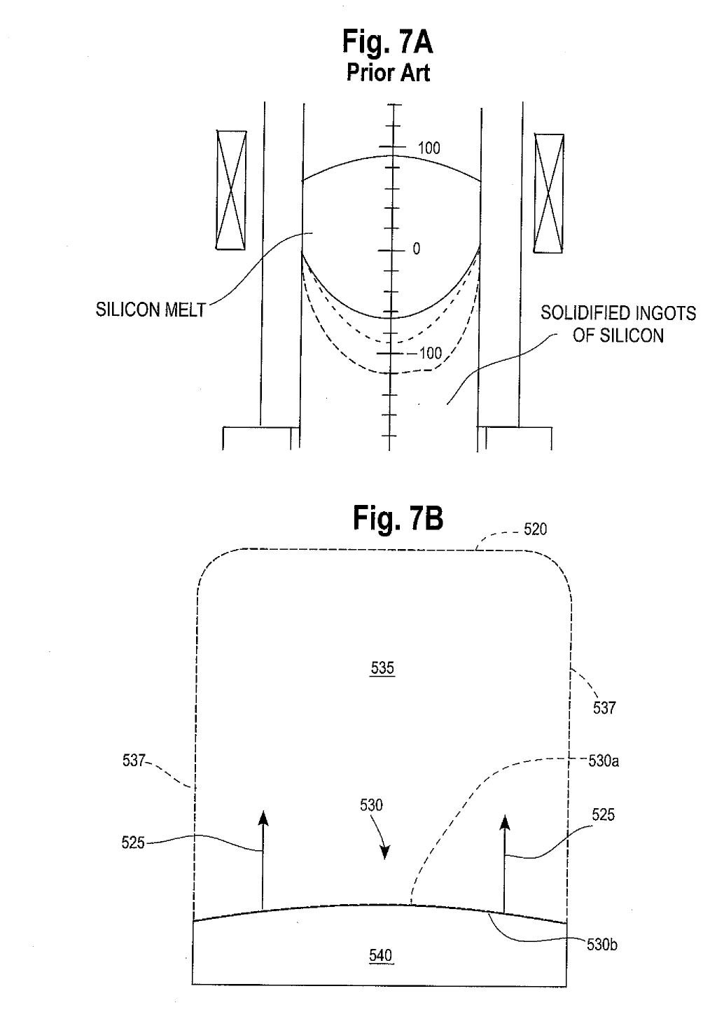

After molten silicon 535 has been produced in or placed into space 560, cooling device 515 may provide a cooling effect at the bottom of molten silicon 535 through plate 550 to begin the solidification of an ingot 540 in molten silicon 535. Ingot 540 may begin to grow from an upper surface 506 of at least one silicon seed 505. Preferably, a portion of at least one silicon seed 505 may be superficially melted before solidification begins, but no seed should be melted through its entire thickness. As shown in FIG. 4B, the growth of solid silicon ingot 540 may start from the bottom portion of molten silicon 535 and may extend upward in a solidification direction 525, as indicated by the arrows. Between molten silicon 535 and solid silicon ingot 540 is a liquid/solid surface 530, which may be substantially flat, as shown in FIG. 4B. When designed correctly, consistent with an embodiment, although not shown in FIG. 4B, liquid/solid interface 530 may have a concave shape, which is shown in greater detail in FIG. 7B discussed below.

Apparatus 500 may be operated in various modes during the casting process. Hereafter, as mentioned above, discussion will focus on the embodiments where a plurality of individual coils are included in inductive coils 510. As can be appreciated by a person of ordinary skill in the art, the discussion that follows may also be applicable to other embodiments where a single coil or a plurality of individual groups of coils are included in inductive coils 510.

In an embodiment, all inductive coils 510 may be supplied with an electrical current to generate electromagnetic field 580 before molten silicon 535 is placed into space 560. All inductive coils 510 and plate 550 may be located at fixed positions relative to molten silicon 535 during the casting process. The electrical current supply to the inductive coils 510 may be selectively controlled. For example, the electrical current supplied to at least one of the inductive coils may be selectively decreased or stopped (i.e., shut off) to begin solidification of molten silicon 535. As ingot 540 grows from the bottom portion of molten silicon 535, the electrical current supplied to inductive coils 510 may be independently or simultaneously controlled.

For example, the electrical current supplied to inductive coils 510 may be selectively stopped (i.e., shut off) beginning at the lowest coils and continuing upwards to the remaining coils as the growth of ingot 540 (i.e., as molten silicon 535 solidifies) as long as electromagnetic field 580 generated by the rest of inductive coils 510 is sufficient to support the liquid block of molten silicon 535 so that gap 570 between vertical molten silicon wall 537 and inductive coils 510 is maintained. Alternatively, as ingot 540 grows (i.e., as molten silicon 535 solidifies) and the volume of molten silicon 535 reduces, the magnitude of electromagnetic field 580 may be reduced to maintain gap 570. That is, the repulsive force required to contain molten silicon 535 will decrease as the volume of molten silicon 535 decreases. Therefore, during the casting process, the electrical current may still be supplied to all inductive coils 510, however, the level of the electrical current may be reduced gradually as the volume of molten silicon 535 reduces.

In another embodiment, as illustrated in FIG. 4B, all inductive coils 510 may be supplied with an electrical current to generate electromagnetic field 580 before molten silicon 535 is placed into space 560. It is noted that for simplicity of illustration, electromagnetic field 580 is not shown in FIG. 4B. The electrical current supplied to all inductive coils 510 may be maintained throughout the entire casting process. The inductive coils 510 may be located at fixed positions during the casting process. As ingot 540 grows from the bottom portion of molten silicon 535, plate 550 may be retracted (moved) in a downward direction 517 substantially opposite to solidification direction 525 of molten silicon 535, as illustrated in FIG. 4B.

In another embodiment, all inductive coils 510 may be supplied with an electrical current to generate electromagnetic field 580 before molten silicon 535 is placed into space 560. As ingot 540 grows, plate 550 may be located at a fixed position, while inductive coils 510 may be retracted (moved) in an upward direction 518 substantially parallel to solidification direction 525 of molten silicon 535, as also illustrated in FIG. 4B. As illustrated in FIG. 4B, the upward direction 518 may also be substantially perpendicular to an upper surface of plate 550. In some embodiments, as inductive coils 510 are moved upward, the electrical current supplied to all inductive coils 510 may be maintained during this movement. The electrical current supplied to inductive coils 510 may be regulated to maintain gap 570. For example, when some upper coils have been moved above surface 520 of molten silicon 535, the electrical current supplied to these upper coils may be reduced or eliminated, as long as electromagnetic field 580 generated by the electrical current supplied to the rest of inductive coils 510 is sufficient to support molten silicon 535 to maintain gap 570 between molten silicon 535 and inductive coils 510.

Consistent with embodiments of the present invention, undesired grain growth along the side portions of ingot 540 may be avoided. In one embodiment, a material other than copper may be used as the inductive coil material. This material should be as conductive as possible in order to achieve efficient inductive heating, but would ideally have a high melting or sublimation temperature, such that the material would remain a solid at casting temperatures without the need for cooling. Consistent with embodiments of the present invention, this induction coil material may be selected from a group of materials including graphite, carbon-fiber carbon composite, silicon carbide, tungsten, tantalum, rhodium, osmium, iridium, platinum and molybdenum. Materials that form silicide compounds with silicon, such as the metals from the above list, may need to be coated with a release material that prevents contact and/or reaction with the liquid silicon. The release material may or may not also have favorable properties as a non-wetting layer. Alloys of elements in the above list may also be suitable, and other high temperature materials may also be used if possessing favorable combinations of electrical conductivity and high temperature structural integrity.

In some embodiments, the traditional copper coils may be coated with a material, which may act as a radiation reflector to reduce heat loss from the molten silicon by reflecting the radiated heat back to the molten silicon. The coating material may be selected from a group of materials including gold, silver, tantalum, aluminum. Alternately, metals used as induction coils may be highly polished in order to improve reflection. Without a crucible wall and without a side cooling mechanism, the entire ingot 540 grown using apparatus 500 may be in a substantially monocrystalline form.

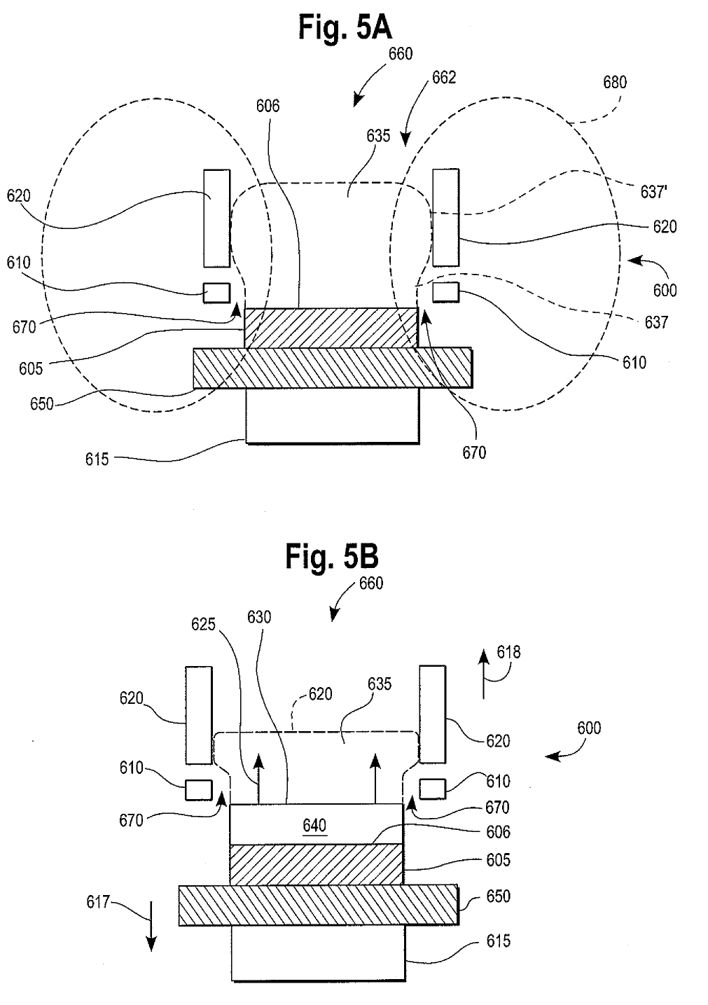

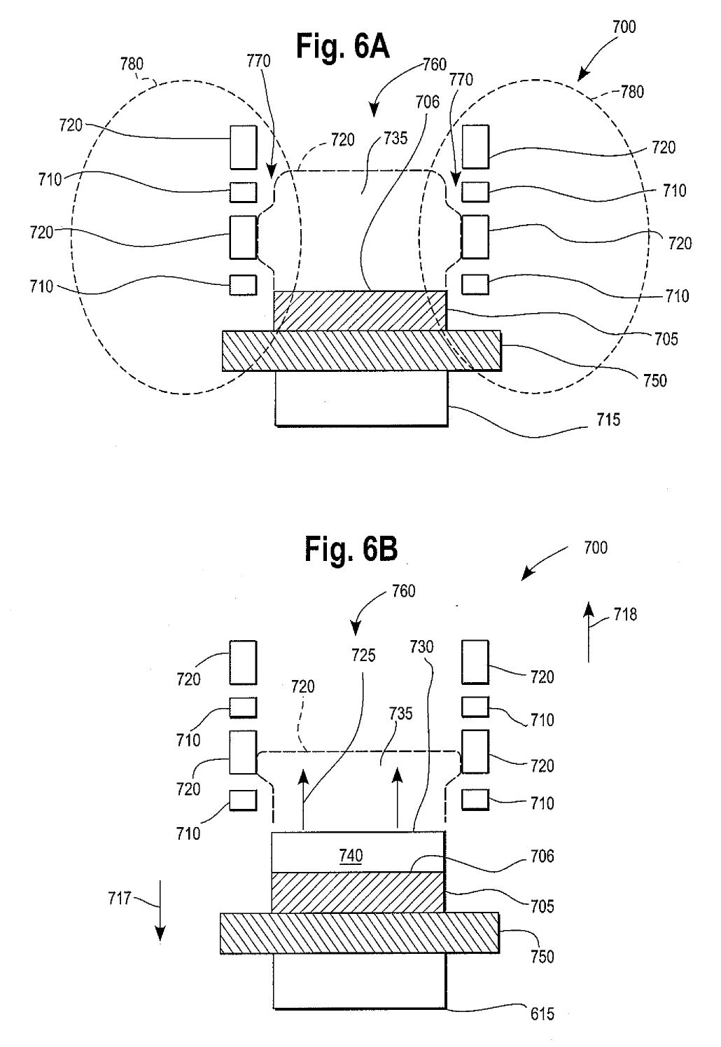

FIGS. 5A and 5B illustrate another exemplary apparatus 600 for casting silicon, and exemplary methods of operating apparatus 600 consistent with the embodiments of present invention. Apparatus 600 may include at least one inductive coil 610, and a crucible wall 620 vertically aligned with the at least one inductive coil 610 configured to form a space 660 to contain molten silicon 635, wherein the at least one inductive coil 610 is configured to generate an electromagnetic field 680 to maintain a gap 670 between molten silicon 635, the at least one inductive coil 610, and/or the at least one crucible wall 620. Many components shown in FIGS. 6A and 6B may be similar to those shown in FIGS. 5A and 5B, therefore, may not be discussed in detail. For example, inductive coil 610, at least one silicon seed 605, plate 650, and cooling device 615 may be similar to inductive coils 510, at least one silicon seed 505, plate 550, and cooling device 515, respectively.

Referring to FIG. 5A, although only one inductive coil 610 is shown for illustration purposes, it is contemplated that more than one coil may be used. Therefore, inductive coil 610 may include a single coil, a plurality of individual coils, or a plurality of individual groups of coils, etc. When inductive coil 610 includes a plurality of individual coils, or a plurality of individual groups of coils, the inductive coils may be independently or simultaneously controlled when an electrical current is supplied thereto. For simplicity, the following discussion will focus on embodiments where inductive coil 610 is a single coil. One of ordinary skill in the art will appreciate that the following discussion may also be applicable to embodiments that include a plurality of individual coils or a plurality of individual groups of coils. When an electrical current is supplied to inductive coil 610, an electromagnetic field 680 similar to electromagnetic field 580 shown in FIG. 4A may be generated. Electromagnetic field 680 may exert a repulsive force on molten silicon 635, thereby providing support to molten silicon 635 such that molten silicon 635 behaves as if it was contained by a solid wall or other surface, as discussed above.

The at least one crucible wall 620 may be made of any suitable materials, such as graphite, fused silica, silicon nitride, etc. Crucible wall 620 may be located over and substantially vertically aligned with inductive coil 610. It is also contemplated that crucible wall 620 may also be located below and vertically aligned with inductive coil 610. Although crucible wall 620 is shown in FIG. 5A as an entire piece, it is also contemplated that crucible wall 620 may include a plurality of slots of walls (not shown), or other combinations. Similarly, the inductive coil may wrap around a series of conductive slots (not shown) which are induced to have current by the coil and which in turn induce a current in the silicon. Crucible wall 620 and inductive coil 610 may form a space 660 for containing molten silicon 635 and ingot 640 (shown in FIG. 5B) solidified from molten silicon 635 during the casting process.

Similar to inductive coils 510 discussed above, crucible wall 620 and inductive coil 610 may be coated with a material comprising a non-stick material and high temperature material, which may be similar to that coated on inductive coils 510 as discussed above, to prevent adhesion between molten silicon 635 and crucible wall 620, and between molten silicon 635 and inductive coil 610. In any case, crucible wall 620 and inductive coil 610 are designed to work together to contain molten silicon 635. The sides of the molten charge 637 and 637′ can be supported by the electromagnetic repulsion force at the bottom, 637, and by contact with the wall at the top, 637′. As the solidification proceeds and the wall 620 and coil 610 can be pulled up in tandem, and the area of wall contact decreases until, at the end of the process, a free-standing solid ingot is left. Crucible wall 620 may contain most of the height of molten silicon 635 simply by acting as a wall, while inductive coil 610 is energized to contain molten silicon 635 at the bottom of space 660. In some ways, inductive coil 610 is acting as a bottom seal to contain molten silicon 635 between crucible wall 620 and plate 650 located above the cooling device 615. In this embodiment, it is important to maintain the solid/liquid interface at the edges within the coil repulsion zone around the entire perimeter of the solidification front.

As cooling device 615 reduces the temperature of molten silicon 635, molten silicon 635 is solidified from its bottom portion, and a solid silicon ingot 640 may start to grow from an upper surface 606 of silicon seed 605. Between molten silicon 635 and solid ingot 640 is a liquid/solid interface 630, which may grow in a solidification direction 625 as indicated by the arrows shown in FIG. 5B.

Consistent with embodiments of the invention, liquid silicon may be introduced into space 660. This may be accomplished by loading solid silicon feedstock and then applying heat (through heaters not illustrated) to melt it, or by melting silicon elsewhere and pouring it into space 660. In either case, from the time that liquid is first present in the system, induction coil 610 may be energized to create a repulsive field that supports the liquid silicon in the system, preventing the liquid silicon from running out through open corners at the bottom of space 660. Once a full load of liquid silicon is attained, optionally atop a silicon seed that has been kept from melting, solidification may start by increasing the cooling to the bottom portion of space 660 through cooling device 615 and decreasing the heating to the top portion of space 660. Preferably, solidification proceeds in such a way that the center solidifies somewhat faster than the edges, creating an interface whose solid portion is convex. At a minimum, random nucleation of crystals due to cooling from the coils must be avoided to maintain the desired crystallinity.

As the solidification proceeds, part of the gap being held by inductive coil 610 freezes. Inductive coil 610 and crucible wall 620 could then be moved relative to the cooling device 615 in order to seal off molten silicon 635 at a higher level and translate the gap upwards. In this way, the ingot 640 (i.e., the solidified silicon) can be separated bit by bit from the supporting crucible wall 620 until, when freezing finishes, the ingot is completely free-standing and has no contact to the crucible wall 620. This prevents the in-diffusion of impurities after solidification and it negates the need to coat crucible wall 620 with a release coating, cutting out silicon nitride contamination. Moreover, if a well-chosen seed 605 is used to start the solidification, then its crystalline structure will be propagated upward without threat from multicrystalline grains nucleating on the sides, as long as inductive coil 610 does not cool the silicon too strongly. Consistent with embodiments of the invention, extreme cooling of the supported silicon is prevented by using inductive coil 610 as described above, which is either allowed to run hot or have a radiation reflection coating thereon.

Space 660 formed by crucible wall 620 may preferably have a substantially square cross section, albeit other shapes of cross section may also be used. A square silicon ingot may be preferable because square bricks may beget square wafers and have the best packing density to go into solar modules with the highest usage rate of the original silicon. Crucible wall 620 is envisioned to be a hot wall, maintained at a temperature at about the temperature of the molten silicon 635 or higher, and therefore undesired solidification from the side wall may be avoided.

Operation of apparatus 600 may be similar to that of apparatus 500 during the casting process. Silicon seed 605 may be placed or placed onto plate 650. An electrical current may be supplied to inductive coil 610 to generate the electromagnetic field 680. Molten silicon 635 may be placed into space 660, or silicon feedstock may be added into space 660, which may be heated and melted, for example, by the heat generated by the electrical current in inductive coil 610, to produce molten silicon 635. Cooling device 615 may reduce the temperature of molten silicon 635 through plate 650 to solidify molten silicon 635. As solid silicon ingot 640 grows in solidification direction 625, in some embodiments, crucible wall 620 and inductive coil 610 may be located at fixed positions relative to molten silicon 635, while plate 650 may be retracted (moved) in a downward direction 617 opposite to solidification direction 625 of solid silicon ingot 640. In some embodiments, crucible wall 620 and inductive coil 610 may be retracted (moved) as a whole in an upward direction 618 parallel solidification direction 625 of solid silicon ingot 640, while plate 650 may be located at a fixed position.

FIGS. 6A and 6B illustrate another exemplary apparatus 700 and exemplary methods of operating apparatus 700 consistent with the disclosed embodiments of present invention. Apparatus 700 may include similar components included in apparatus 600, except that apparatus 700 may include a plurality of crucible walls 720 and a plurality of inductive coils 710 forming a space 760 for containing molten silicon 735. Each of the plurality of crucible walls 720 and each of the plurality of inductive coils 710 may be arranged in an alternating order. Each crucible wall 720 may be similar to crucible wall 620 shown in FIGS. 6A and 6B, and each inductive coil 710 may be similar to inductive coil 610 shown in FIGS. 6A and 6B. Plate 750, silicon seed 705, and cooling device 715 may be similar to plates 550 and 650, silicon seeds 505 and 605, and cooling device 515 and 615, respectively. When an electrical current is supplied to inductive coils 710, an electromagnetic field 780 may be generated to support molten silicon 735 and maintain gap 770 between molten silicon 735 and inductive coils 710 and crucible walls 720. Sides of molten silicon 735 can be supported by contact with crucible walls 720 as shown. Elements of apparatus 700 similar to that introduced in FIGS. 6A and 6B are not discussed in detail.

Operation of apparatus 700 may also be similar to that of apparatus 600 as shown in FIG. 6B. In some embodiments, as solid silicon ingot 740 grows in solidification direction 725, the plurality of crucible walls 720 and inductive coils 710 may be retracted (moved) together in an upward direction 718 substantially parallel to solidification direction 725, while plate 750 may be maintained at a fixed position. As illustrated in FIG. 6B, the upward direction 718 may also be substantially perpendicular to an upper surface of plate 750. In some embodiments, as solid silicon ingot 740 grows, plate 750 may be retracted (moved) in a downward direction 717 substantially opposite to solidification direction 725, while the plurality of crucible walls 720 and the plurality of inductive coils 710 may be each maintained at a fixed position.

Consistent with the embodiments of present invention, when growth of solid silicon ingot (e.g., 540, 640, 740) is substantially completed, there may be a portion of molten silicon (e.g., 535, 635, 735) left at the top of the solid silicon ingot (e.g., 540, 640, 740). This remaining portion of molten silicon may contain impurities, therefore, may not be desirable to be crystallized into the ingot. To discharge this remaining portion of molten silicon, the electrical current supplied to inductive coils may be stopped so that the electromagnetic field (e.g., 580) is no longer present. Without the support by the repulsive force generated by the electromagnetic field, the molten silicon can no longer be held in place. Therefore, molten silicon will flow with gravity out of the space (e.g., 560, 660, 760) enclosed by inductive coils (e.g., 510, 610, 710) and away from the apparatus (e.g., 500, 600, 700).

In some embodiments, it is also contemplated that current supplied to the inductive coils may be maintained, but the inductive coils (e.g., 510, 610, 710) may be moved away from molten silicon so that the repulsive force supporting molten silicon is removed. Molten silicon will then flow down due to gravity and away from the apparatus (e.g., 500, 600, 700). Thus, consistent with embodiments of the invention, the electrical current supplied to inductive coils may be purposefully stopped at about greater than or equal to 95% solidification of the ingot (i.e., about less than or equal to 5% of the molten silicon remaining), to let the remaining portion of molten silicon pour down and away from the ingot. This process can improve the quality of the cast ingot by providing for the removal of the high impurity remaining molten silicon before it solidifies and potentially contaminates the ingot.

Consistent with embodiments of present invention, the electrical current supplied to the inductive coils (e.g., 510, 610, 710) may have a frequency of 10 kHz or higher. For example, the following Tables 1-3 indicate the maximum height supportable for a column of molten silicon given different frequencies and current values sufficient to maintain a 2 mm gap between the molten silicon and the inductive coils.

TABLE 1
Current = 1000 (A)

| Frequency | Repulsive Force | Equivalent Si |
|---|---|---|
| (kHz) | (Pa) | Height (cm) |
| 450 | 2388 | 10.5 |
| 800 | 3441 | 15.1 |
| 1000 | 3781 | 16.6 |
| 5000 | 2598 | 11.4 |

TABLE 2
Current = 2000 (A)

| Frequency | Repulsive Force | Equivalent Si |
|---|---|---|
| (kHz) | (Pa) | Height (cm) |
| 200 | 4717 | 20.7 |
| 400 | 8736 | 38.3 |

TABLE 3
Current = 4000 (A)

| Frequency | Repulsive Force | Equivalent Si |
|---|---|---|
| (kHz) | (Pa) | Height (cm) |
| 50 | 4326 | 18.9 |
| 80 | 7300 | 32.0 |
| 100 | 9294 | 40.7 |

FIG. 7A shows a profile (i.e., surface shape) of a liquid/solid interface between molten silicon and solidified silicon ingot for a casting process conducted using a known apparatus such as that disclosed in U.S. Pat. No. 6,994,835 (the '835 patent). As illustrated in FIG. 7A, the solid/liquid interface in the bottomless crucible is recessed from an lower end of the coil as deep as 100 mm or more (e.g., −100 mm from the 0 point). The '835 patent further discloses utilizing plasma heating to reduce the recession.

FIG. 7B shows a profile of molten silicon 535 and solid silicon 540, which may be obtained during a casting process when the disclosed apparatus according to the present invention, e.g., apparatus 500, is used, consistent with embodiments of the present invention. In some embodiments, the profile of the molten silicon 535 includes substantially vertical walls 537 and a substantially flat surface 520. With this profile (surface shape) shown in FIG. 7B, when cutting solid silicon 540 into smaller pieces, e.g., rectangular bricks, the unusable portion of solid silicon 540 may be reduced, compared with the example shown in FIG. 7A. In contrast, the shape of FIG. 7A may result in a significant amount of unusable cast material from the resulting ingot, due to impurities and/or undesired crystal growth. FIG. 7B also shows an exemplary enlarged view of liquid/solid interface 530, which includes a liquid portion 530a and a solid portion 530b. The liquid/solid interface 530 is formed between molten silicon 530 and solid silicon ingot 540 such that at the liquid/solid interface 530, solid portion 530b of solid silicon ingot 540 is convex toward the interface and liquid portion 530a of molten silicon 530 is concave toward the interface. The degree of the concave/convex liquid/solid interface shape may be related to the size of the apparatus, the temperature, the speed of the growth of solid ingot, the strength of the electromagnetic field 580, etc., and may be adjusted to achieve a desired shape.

It will be apparent to those skilled in the art that various modifications and variations can be made in the disclosed systems and methods without departing from the scope or spirit of the invention. Although casting of silicon has been primarily described herein, other semiconductor materials and nonmetallic crystalline materials that are electrically conductive while molten may be cast using the apparatus and methods of this invention without departing from the scope and spirit of the invention. For example, casting of other such materials is possible, such as zinc, gallium, selenium, cadmium, indium, tin, antimony, tellurium, lead, bismuth, gallium arsenide, silicon germanium, gallium nitride, zinc sulfide, gallium indium arsenide, indium antimonide, germanium, yttrium barium oxides, lanthanide oxides, magnesium oxide, and other semiconductors, oxides, and intermetallics with a liquid phase. It will now be apparent to one of ordinary skill in the art that any material including any metal or semimetal which can withstand the temperatures required for casting without sublimating could be crystallized from their molten state by the above described apparatus and methods. These metals and semimetals comprise, for example, metals and other compounds comprising one or more of B, C, N, O, Al, Si, P, S, Zn, Ga, Ge, As, Se, Cd, In, Sn, Sb, Te, Hg, Pb, and Bi. The above-described metals and semimetals and semiconductor materials and nonmetallic crystalline materials are referred to herein as electronic materials. Other embodiments of the invention will be apparent to those skilled in the art from consideration of the specification and practice of the invention disclosed herein. It is intended that the specification and examples be considered exemplary only, with a true scope and spirit of the invention being indicated by the following claims.

What is claimed is:

1. An apparatus for manufacturing cast silicon, comprising:
a plate;
a cooling device;
molten silicon; and
a plurality of inductive coils configured to form a space to contain the molten silicon, and configured to generate an electromagnetic field when an electrical current is supplied to the inductive coils to support the molten silicon so that a gap is maintained in a portion of the space between at least one substantially vertical wall of the molten silicon and at least one of the inductive coils, and when a portion of the molten silicon solidifies into a solid silicon ingot as the molten silicon is cooled by the cooling device, a liquid/solid interface is formed between the molten silicon and the solid silicon ingot such that at the liquid/solid interface the solid silicon ingot is convex toward the interface and the liquid molten silicon is concave toward the interface.

2. The apparatus of claim 1, wherein the plurality of inductive coils are configured to be independently controlled when the electrical current is supplied thereto.

3. The apparatus of claim 1, wherein the plurality of inductive coils are configured to be simultaneously controlled when the electrical current is supplied thereto.

4. A method of manufacturing cast silicon, comprising:
placing at least one silicon seed on a plate;
placing molten silicon onto the at least one seed;
supplying an electrical current to a plurality of inductive coils;
generating an electromagnetic field with the plurality of inductive coils to exert a force upon the molten silicon and form a gap between at least one substantially vertical wall of the molten silicon and at least one of the inductive coils; and
cooling the molten silicon from the plate.

5. The method of claim 4, wherein generating the electromagnetic field includes supplying an electrical current to at least one of the plurality of inductive coils.

6. The method of claim 4, further including controlling the plurality of inductive coils independently when an electrical current is supplied thereto.

7. The method of claim 6, wherein controlling the plurality of inductive coils independently further includes selectively supplying an electrical current to at least one of the inductive coils.

8. The method of claim 7, wherein selectively supplying the electrical current further includes selectively stopping the electrical current supply to at least one of the inductive coils to begin solidification of the molten silicon.

9. The method of claim 4, further including controlling the plurality of inductive coils simultaneously when an electrical current is supplied thereto.

10. The method of claim 4, further including moving at least one of the plurality of inductive coils in a direction parallel to a solidification direction of the molten silicon.

11. The method of claim 4, further including moving at least one of the plurality of inductive coils in a direction perpendicular to a fixed surface of the plate.

12. The method of claim 4, further including moving the plate in a direction opposite to a solidification direction of the molten silicon.

13. The method of claim 4, further including moving the plate in a direction opposite to a solidification direction of the molten silicon while the inductive coils are located at fixed positions relative to the molten silicon.

14. The method of claim 4, wherein the generating an electromagnetic field is stopped when about 5% or less of the molten silicon remains during the cooling.

15. A method of manufacturing cast silicon, comprising:
placing at least one silicon seed on a plate;
placing a silicon feedstock onto the at least one seed;
supplying an electrical current to a plurality of inductive coils;
generating heat with the plurality of inductive coils to melt at least a portion of the silicon feedstock into molten silicon;
generating an electromagnetic field with the plurality of inductive coils to exert a force upon the molten silicon and form a gap between at least one substantially vertical wall of the molten silicon and at least one of the inductive coils; and
cooling the molten silicon from the plate to solidify at least a portion of the molten silicon into solid silicon ingot, wherein a liquid/solid interface between the molten silicon and the solid silicon ingot has a concave shape.

16. An apparatus for manufacturing cast silicon, comprising:
a plate;
a cooling device;
molten silicon;
at least one inductive coil; and
a crucible having at least one crucible wall vertically aligned with the at least one inductive coil, wherein the crucible wall and the at least one inductive coil are configured to form a space to contain the molten silicon, and wherein the at least one inductive coil is configured to generate an electromagnetic field to maintain a gap in the space between the molten silicon, the at least one inductive coil, and the at least one crucible wall.

17. The apparatus of claim 16, wherein the at least one inductive coil includes a plurality of inductive coils that are independently controlled when an electrical current is supplied thereto.

18. The apparatus of claim 16, wherein the at least one inductive coil includes a plurality of inductive coils that are simultaneously controlled when an electrical current is supplied thereto.

19. A method of manufacturing cast silicon, comprising:
placing at least one silicon seed on a plate;
placing molten silicon onto the at least one seed;
generating an electromagnetic field with at least one inductive coil to exert a force upon the molten silicon and form a gap between the molten silicon and the at least one inductive coil; and
cooling the molten silicon from the plate.

20. The method of claim 19, wherein generating the electromagnetic field includes supplying an electrical current to the at least one inductive coil.

21. The method of claim 20, further including regulating the electrical current supplied to the at least one inductive coil to maintain the gap.

22. The method of claim 19, wherein the at least one inductive coil includes a plurality of inductive coils, the method further including controlling the plurality of inductive coils independently when an electrical current is supplied thereto.

23. The method of claim 22, wherein controlling the plurality of inductive coils independently includes selectively supplying an electrical current to the plurality of inductive coils.

24. The method of claim 23, wherein selectively supplying the electrical current to the plurality of inductive coils further includes selectively stopping the electrical current supply to at least one of the plurality of inductive coils to begin solidification of the molten silicon.

25. The method of claim 19, wherein the at least one inductive coil includes a plurality of inductive coils, the method further including controlling the plurality of inductive coils simultaneously when an electrical current is supplied thereto.

26. The method of claim 19, further including moving the at least one inductive coil in a direction parallel to a solidification direction of the molten silicon.

27. The method of claim 19, further including moving the at least one inductive coil in a direction parallel to a solidification direction of the molten silicon while the plate located at a fixed position.

28. The method of claim 19, further including moving the plate in a direction opposite to a solidification direction of the molten silicon.

29. The method of claim 19, further including moving the plate in a direction opposite to a solidification direction of the molten silicon while the at least one inductive coil is located at a fixed position.

30. The method of claim 19, further including moving the at least one crucible wall with the at least one inductive coil in a direction parallel to the solidification direction of the molten silicon.

31. The method of claim 19, further including moving the at least one crucible wall with the at least one inductive coil in a direction parallel to the solidification direction of the molten silicon while the plate is maintained at a fixed position.

32. The method of claim 19, wherein the at least one crucible wall further includes a plurality of crucible walls, and the at least one inductive coil further includes a plurality of inductive coils, the method further including moving the plurality of crucible walls with the plurality of inductive coils in a direction parallel a solidification direction of the molten silicon.

33. The method of claim 19, wherein the at least one crucible wall further includes a plurality of crucible walls, and the at least one inductive coil further includes a plurality of inductive coils, the method further including moving the plurality of crucible walls with the plurality of inductive coils in a direction parallel a solidification direction of the molten silicon while the plate is maintained at a fixed position.

34. The method of claim 19, wherein the at least one crucible wall further includes a plurality of crucible walls, and the at least one inductive coil further includes a plurality of inductive coils, the method further including moving the plate in a direction opposite to a solidification direction of the molten silicon.

35. The method of claim 19, wherein the at least one crucible wall further includes a plurality of crucible walls, and the at least one inductive coil further includes a plurality of inductive coils, the method further including moving the plate in a direction opposite to a solidification direction of the molten silicon while the plurality of crucible walls and the plurality of inductive coils are each maintained at a fixed position.

36. The method of claim 19, wherein the generating an electromagnetic field is stopped when about 5% or less of the molten silicon remains during the cooling.

37. A method of manufacturing cast silicon, comprising:
placing at least one silicon seed on a plate;
placing a silicon feedstock onto the at least one seed;
supplying an electrical current to at least one inductive coils;
generating heat with the at least one inductive coil to melt at least a portion of the silicon feedstock into molten silicon;
generating an electromagnetic field with the at least one inductive coil to exert a force upon the molten silicon and form a gap between the molten silicon and the at least one inductive coil; and
cooling the molten silicon from the plate to solidify at least a portion of the molten silicon into solid silicon ingot, wherein a liquid/solid interface between the molten silicon and the solid silicon ingot has a concave shape.

38. An apparatus for manufacturing a cast electronic material, comprising:
a plate;
a cooling device; and
a plurality of inductive coils configured to form a space to contain molten electronic material, and configured to generate an electromagnetic field when an electrical current is supplied to the inductive coils to support the molten electronic material so that a gap is maintained in a portion of the space between at least one substantially vertical wall of the molten electronic material and at least one of the inductive coils, and when a portion of the molten electronic material solidifies into a solid ingot of the electronic material as the molten electronic material is cooled by the cooling device, a liquid/solid interface is formed between the molten electronic material and the solid ingot of the electronic material such that at the liquid/solid interface the solid ingot of electronic material is convex toward the interface and the liquid molten electronic material is concave toward the interface.

39. The apparatus of claim 38 wherein the electronic material that can be cast is silicon.

40. The apparatus of claim 38, wherein the space formed by the plurality of inductive coils has a substantially square or rectangular cross section.

41. The apparatus of claim 38, wherein the plurality of inductive coils are configured to be independently controlled when the electrical current is supplied thereto.

42. The apparatus of claim 38, wherein the plurality of inductive coils are configured to be simultaneously controlled when the electrical current is supplied thereto.

43. The apparatus of claim 38, wherein the gap separates the molten electronic material from the plurality of inductive coils.

44. The apparatus of claim 43, wherein the space is further configured to contain a solid conductive material portion solidified from the molten conductive material.

45. The apparatus of claim 38, wherein the plate and the inductive coils are located at fixed positions relative to the molten conductive material.

46. The apparatus of claim 45, wherein the electrical current supplied to the inductive coils is shut off progressively as the molten conductive material solidifies.

47. The apparatus of claim 38, wherein the inductive coils are configured to generate heat within the space when the electrical current is supplied thereto.

48. The apparatus of claim 38, wherein at least one of the plate or the inductive coils is moveable.

49. The apparatus of claim 38, wherein the inductive coils are located at fixed positions, and wherein the plate is moveable in a direction opposite to a solidification direction of the molten conductive material.

50. The apparatus of claim 38, wherein the plate is located at a fixed position, and wherein the inductive coils are moveable in a direction parallel to a solidification direction of the molten conductive material.

51. The apparatus of claim 38, wherein the inductive coils are coated with a material comprising a non-stick and high temperature material.

52. The apparatus of claim 38, wherein the inductive coils are made of a material that is electrically conductive and has a high melting or sublimation temperature.

53. The apparatus of claim 38, wherein the inductive coils are made of one or more materials selected from a group of materials consisting of graphite, carbon-fiber carbon composite, silicon carbide, tungsten, tantalum, rhodium, osmium, iridium, platinum, and molybdenum.

54. The apparatus of claim 38, wherein the inductive coils are made of copper and are coated with a material to reflect heat radiation from the molten silicon, thereby reducing heat loss from the molten electronic material.

55. The apparatus of claim 54, wherein the material coated on the inductive coils is selected from a group of materials consisting of gold, silver, tantalum, aluminum, and copper.

56. The apparatus of claim 38, wherein the inductive coils are made of highly polished metals.

57. An apparatus for manufacturing cast electronic material, comprising:
a plate;
a cooling device;
at least one inductive coil; and
a crucible having at least one crucible wall vertically aligned with the at least one inductive coil, wherein the crucible wall and the at least one inductive coil are configured to form a space to contain molten electronic material, and wherein the at least one inductive coil is configured to generate an electromagnetic field to maintain a gap in the space between the molten electronic material, the at least one inductive coil, and the at least one crucible wall.

58. The apparatus of claim 57, wherein the space formed by the crucible wall and the inductive coil has a substantially square or rectangular cross section.

59. The apparatus of claim 57, wherein the at least one inductive coil includes a plurality of inductive coils that are independently controlled when an electrical current is supplied thereto.

60. The apparatus of claim 57, wherein the at least one inductive coil includes a plurality of inductive coils that are simultaneously controlled when an electrical current is supplied thereto.

61. The apparatus of claim 57, wherein the space is configured to contain the molten electronic material.

62. The apparatus of claim 61, wherein the space is further configured to contain a solid electronic material portion solidified from the molten electronic material.

63. The apparatus of claim 57, wherein at least one of the plate and the least one inductive coil is moveable.

64. The apparatus of claim 57, wherein the at least one inductive coil is located at a fixed position, and wherein the plate is moveable in a direction opposite to a solidification direction of the molten electronic material.

65. The apparatus of claim 57, wherein the plate is located at a fixed position, and wherein the at least one inductive coil is moveable in a direction parallel to a solidification direction of the molten electronic material.

66. The apparatus of claim 57, wherein the at least one inductive coil is coated with a material comprising a non-stick and high temperature material.

67. The apparatus of claim 57, wherein the at least one crucible wall and the at least one inductive coil are moveable in a direction parallel to the solidification direction of the molten electronic material.

68. The apparatus of claim 57, wherein the at least one crucible wall further includes a plurality of walls, and the at least one inductive coil further includes a plurality of inductive coils, and wherein each of the plurality of crucible walls and the each of the plurality of inductive coils are arranged in an alternating order.

69. The apparatus of claim 57, wherein the at least one inductive coil is made of a material that is electrically conductive and has a high melting or sublimation temperature.

70. The apparatus of claim 57, wherein the at least one inductive coil is made of one or more materials selected from a group of materials consisting of graphite, carbon-fiber carbon composite, silicon carbide, tungsten, tantalum, rhodium, osmium, iridium, platinum, and molybdenum.

71. The apparatus of claim 57, wherein the at least one inductive coil is made of copper and is coated with a material to reflect heat radiation from the molten silicon, thereby reducing heat loss from the molten electronic material.

72. The apparatus of claim 57, wherein the material coated on the at least one inductive coil is selected from a group of materials consisting of gold, silver, tantalum, aluminum, and highly polished copper.

73. The apparatus of claim 57, wherein a temperature of the at least one crucible wall is at about the temperature of the molten silicon or higher.

74. The apparatus of claim 57, wherein at least a portion of the molten electronic material solidifies into a solid ingot of the electronic material as the molten electronic material is cooled by the cooling device, and wherein a liquid/solid interface between the molten electronic material and the solid ingot of electronic material has a concave shape.

75. The apparatus of claim 57 wherein the electronic material that can be cast is silicon.
